(19) United States
(12) Patent Application Publication
(10) Pub. No.: US 2015/0115651 A1
(43) Pub. Date: Apr. 30, 2015

(54) INFLATABLE AERODYNAMIC DRAG REDUCING DEVICE

(71) Applicant: Justin CONBOY, Galway (IE)

(72) Inventor: Justin Conboy, Galway (IE)

(21) Appl. No.: 14/405,582

(22) PCT Filed: Jun. 5, 2013
(86) PCT No.: PCT/EP2013/061625

§ 371 Date: Dec. 4, 2014

(30) Foreign Application Priority Data
Jun. 5, 2012 (GB) 1209929.7

(51) Int. Cl. B62D 35/00

(52) U.S. Cl. CPC B62D 35/004
USPC 296/180.2

(57) ABSTRACT

The present invention is directed towards an aerodynamic drag reducing device for an articulated road vehicle; the articulated road vehicle comprising a tractor unit and a trailer unit, with the trailer tractor unit pivotably connectable to the tractor unit such that a gap is formed intermediate the tractor unit and the trailer unit when the trailer unit is connected to the tractor unit; the aerodynamic drag reducing device comprising an inflatable enclosure (2)attached to a support framework (10); the support framework (10) being mountable on a rearward facing portion of the tractor unit or on a forward facing portion of the trailer unit, so as to retain the inflatable enclosure (2) in the gap intermediate the tractor unit and the trailer unit; the inflatable enclosure (2) being made of a flexible material; wherein, the inflatable enclosure (2) comprises an outer wall (3) and an inner wall (4) spaced apart and defining an air-receiving cavity therebetween; and, the outer wall (3) and inner wall (4) being curved respectively so that the air-receiving cavity defined therebetween comprises a substantially semi-annular transverse cross-section. The purpose of the aerodynamic drag reducing device is to reduce the aerodynamic drag and hence result in a more fuel efficient articulated road vehicle. Tests have shown that up to an 8% reduction in fuel usage can be achieved by installing such an aerodynamic drag reducing device to a standard articulated road vehicle. Clearly, this can result in significant sayings.

### INTRODUCTION

The present invention relates to an aerodynamic drag reducing device for an articulated road vehicle. The aerodynamic drag reducing device being of the type comprising an inflatable enclosure made of a flexible material, with the aerodynamic drag reducing device being suitable for mounting on the rear of a tractor unit.

Articulated road vehicles are generally of the type comprising a tractor unit and a trailer unit, with the trailer unit being hitched to the tractor unit so as to be pivotable relative to one another. This hitched arrangement results in a gap being formed intermediate the trailer unit and the tractor unit. This gap is generally in the region of 1 m to 2 m in length from a rear of the tractor unit to a front face of the trailer unit. The tractor unit and trailer unit are electrically and pneumatically connected using wiring looms and hoses; the hoses and wiring are most typically found adjacent the hitch connection.

As such types of articulated road vehicles are, for the most part, used as goods carriers, the cost of transporting the goods is extremely important. Thus, the fuel efficiency of these types of articulated road vehicles is scrutinised and attempts to maximise the fuel efficiency are continually made. The gap intermediate the trailer unit and the tractor unit can result in aerodynamic drag on the articulated vehicle which negatively impacts on the articulated vehicle's fuel efficiency. Apparatus for overcoming this problem by obviating or at least minimising the aerodynamic drag effects have long been sought.

U.S. Patent Publication Number U.S. Pat. No. 4,036,519 (AEROSPAN CORPORATION) describes a drag reduction device in the form of a fully inflatable bag which is mounted on the cab of a tractor unit and extends between the cab and the trailer body to provide for a smooth non-turbulent flow of air around the cab and to the side and top walls of the trailer unit. U.S. Patent Publication Number U.S. Pat. No. 4,611,847 (NAVISTAR INTERNATIONAL CORPORATION) describes a somewhat similar device in the form of an inflatable and extendable skirt which has inflatable fluid pockets integral therewith. There is included quite elaborate inflation means and also has detraction means to roll the skirt into a coiled deflated position close to the tractor cab. Moreover, U.S. Patent Publication Number U.S. Pat. No. 4,688,841 (MOORE) discloses another construction of device which includes a fabric enclosure mounted on the rear end of the vehicle which is inflated by a pressure differential between the outer and inner surfaces of the fabric created by the forward movement of the vehicle. U.S. Patent Publication Number U.S. Pat. No. 8,162,381 (TECAMA HOLDING AS) also describes another inflatable drag reduction device again in the form of an inflatable bag which comprises a plurality of co-joined panels. The bag further comprises internal ribs of a generally non-elastic material attached to the internal surfaces of the panels which assists the bag in assuming that predetermined geometrical shape in which the panels are prevented from billowing outwards. This however is a very elaborate way of overcoming a problem that is undoubtedly very important, namely, the control of the enclosure/bag or forever under crosswinds and specifically when the vehicle is slowing down.

The present invention is directed towards providing a simple construction of aerodynamic drag reducing device which will overcome some of the problems in respect of such aerodynamic drag reducing devices in a manner which is simple, effective and relatively inexpensive avoiding the necessity to use any elaborate or complex equipment.

### STATEMENTS OF INVENTION

The present invention is directed towards an aerodynamic drag reducing device for an articulated road vehicle; the articulated road vehicle comprising a tractor unit and a trailer unit, with the trailer tractor unit pivotably connectable to the tractor unit such that a gap is formed intermediate the tractor unit and the trailer unit when the trailer unit is connected to the tractor unit; the aerodynamic drag reducing device comprising an inflatable enclosure attached to a support framework; the support framework being mountable on a rearward facing portion of the tractor unit or on a forward facing portion of the trailer unit, so as to retain the inflatable enclosure in the gap intermediate the tractor unit and the trailer unit; the inflatable enclosure being made of a flexible material; wherein, the inflatable enclosure comprises an outer wall and an inner wall spaced apart and defining an air-receiving cavity therebetween; and, the outer wall and inner wall being curved respectively so that the air-receiving cavity defined therebetween comprises a substantially semi-annular transverse cross-section.

The purpose of the aerodynamic drag reducing device is to reduce the aerodynamic drag and hence result in a more fuel efficient articulated road vehicle. Tests have shown that up to an 8% reduction in fuel usage can be achieved by installing such an aerodynamic drag reducing device to a standard articulated road vehicle. Clearly, this can result in significant savings.

A further advantage of using an inflatable enclosure that has an outer wall and an inner wall spaced apart, which in turn define an air-receiving cavity therebetween, is that the inflatable enclosure may be inflated and thusly become erect with a minimum of air flow through its at least one air inlet. In prior art solutions, the gap between the tractor and trailer is substantially filled entirely with a bag which needs to be inflated, and thus the volume of air to do so is greater than the volume of air required to inflate the air receiving cavity. Moreover, the outer wall and inner wall are curved respectively so that the air-receiving cavity defined therebetween comprises a substantially semi-annular transverse cross-section, and this is advantageous as the articulated road vehicle may corner without the tractor or trailer pressing against and deflating the inflatable enclosure. The curvature of the walls results in an arcuate rearwardly facing face on the inflatable enclosure which allows the tractor and trailer unit to pivot relative to one another during cornering manoeuvres without the tractor or trailer unit abutting against and/or pressing against the inflatable enclosure, which would have otherwise deflated the inflatable enclosure and increased the risk of damage to the inflatable enclosure.

In a further embodiment, the inflatable enclosure is inflated by air entering through at least one air inlet on the aerodynamic drag reducing device. In another embodiment, the at least one air inlet is connected to the inflatable enclosure.

In a further embodiment, when the air-receiving cavity is inflated, an inner void is established between the inner wall and the supporting framework, whereby the inner void comprises a substantially D-shaped transverse cross-section.

In a further embodiment, the aerodynamic drag reducing device further comprises radial support rods which support the inflatable enclosure, from a substantially vertical support post on the support framework, at a plurality of points on the inner wall of the inflatable enclosure. These support rods are beneficial as they assist in maintaining the shape of the inflatable enclosure in low speed conditions where the air flow through the at least one air inlet may not have been otherwise sufficient to maintain the inflatable enclosure in a fully inflated and erect state.

In a further embodiment, when the air-receiving cavity is inflated, the inflatable enclosure is formed into a substantially semi-cylindrical shape having an arcuate outer face formed by the outer wall of the inflatable enclosure, and a substantially semi-circular top face and a substantially semi-circular bottom face.

In a further embodiment, the substantially semi-circular top face slopes upwardly away from the supporting framework.

In a further embodiment, the substantially semi-circular bottom face slopes upwardly away from the supporting framework. This provides space for the hose and wiring to extend from the tractor unit to the trailer unit.

In a further embodiment, the inflatable enclosure is attached to a first side of the support framework, which is adjacent a first side of the tractor unit; and the outer wall of the inflatable enclosure arches outwardly away from the tractor unit to a substantially centralised outermost point before curving back towards the tractor unit so as that the inflatable enclosure is attached to a second side of the support framework, which is opposite the first side of the support framework and is also adjacent a second side of the tractor unit.

In a further embodiment, the at least one air inlet comprises an opening which is located on the substantially semi-circular top face of the inflatable enclosure adjacent an abutment point with the outer wall of the inflatable enclosure.

In a further embodiment, the at least one air inlet comprises a pair of conically shaped funnels which direct air into the air-receiving cavity of the inflatable enclosure.

In a further embodiment, the pair of conically shaped funnels are located on either side of the inflatable enclosure.

In a further embodiment, the inner wall is comprised of a semi-rigid plastics foam material. The use of a semi-rigid plastics material allows the aerodynamic drag reducing device to be maintained in a substantially erect state, even when the articulated vehicle is stationary or only travelling at low speed.

In a further embodiment, the outer wall is comprised of a plastics material. Preferably the plastics material is a woven polypropylene material.

In a further embodiment, the inflatable enclosure is attached to the support framework using a plurality of fastening means.

In a further embodiment, the fastening means are hook and eye fasteners. In a further embodiment, the fastening means are snap fasteners. In yet a further embodiment, the fastening means are hook and loop fasteners. In another embodiment, the inflatable enclosure is attached to the support framework using a zip.

In a further embodiment, the inflatable enclosure comprises at least one air outlet.

In a further embodiment, the at least one air outlet is adjustable in dimension to permit a greater or lesser rate of air flow through the at least one air outlet.

In a further embodiment, the at least one air inlet is adjustable in dimension to permit a greater or lesser rate of air flow through the at least one air inlet.

In a further embodiment, the aerodynamic drag reducing device further comprises radially extending ties which bias the inflatable enclosure towards a retracted state when the inflatable enclosure is not inflated, wherein the radially extending ties extend, from a substantially centralised position on the framework, radially outwardly towards a plurality of points on the inner wall of the inflatable enclosure.

In a further embodiment, the inflatable enclosure comprises a hose and wiring channel provided on a bottom face of the inflatable enclosure.

In a further embodiment, the inflatable enclosure is comprised of a woven polypropylene plastics material.

The invention is further directed towards an aerodynamic drag reducing device for an articulated road vehicle generally of the type comprising a tractor unit and a trailer unit, the aerodynamic drag reducing device being of the type comprising an inflatable enclosure of a flexible material for mounting on the rear of the tractor unit wherein the enclosure comprises an outer wall and an inner wall spaced apart and defining an elongate inflatable enclosure for mounting on a rear face of the tractor unit adjacent one side and for extending rearwardly of the tractor unit to encompass an inner void and terminating on the rear face of the tractor unit being mounted adjacent the other side of the tractor unit.

The clear advantage of this is that the enclosure does not need to be custom-built for various types of semi-trailer unit but can accommodate different spacings between the tractor unit and a wide variety of semi-trailer units.

In one embodiment, the enclosure is self-inflatable by air entering through air inlets arranged on the aerodynamic drag reducing device.

In one embodiment, the inflatable enclosure is substantially D-shape terminating in an arcuate surface.

In another embodiment of the invention, a top flexible cover sheet is provided for the enclosure.

In a further embodiment of the invention, there is provided a bottom flexible sheet for the enclosure which is configured to accommodate equipment between the tractor unit and semi-trailer unit.

In another embodiment the invention, there is provided a rearwardly directed support bar for the enclosure mounted by means of a base plate on the tractor unit. In one embodiment this latter support bar is biased outwards away from the base plate on the tractor unit.

In yet a further embodiment of the invention, the base plate on the tractor unit carries a plurality of flexible ties which can be connected to portions of the enclosure to retain the enclosure so that they cannot billow outwards beyond the sides of the tractor unit. Ideally these ties are either of an elastic material or incorporate some biasing means, whereby on the enclosure been deflated the enclosure is pulled in words and towards the rear of the tractor unit.

In one particular embodiment of the invention, mounting means are provided for securing to the tractor unit and essentially comprise either one of 3 sided or 4 sided framework encompassing at least the top and sides of the tractor unit to which the enclosure can be attached. In this embodiment air inlets for the enclosure are provided in the framework adjacent the lower portion of each adjacent the sides of the tractor unit.

### DETAILED DESCRIPTION OF THE INVENTION

The invention will be more clearly understood by the following description of some embodiments thereof, given by way of example only with reference to the accompanying drawings in which

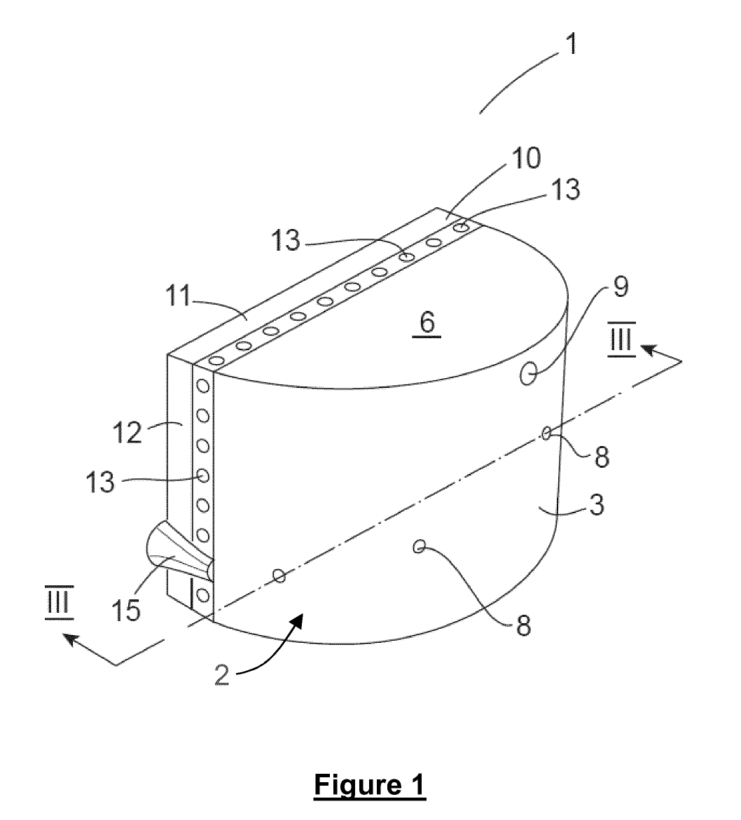

FIG. 1 is a perspective view of an aerodynamic drag reducing device according to the invention;

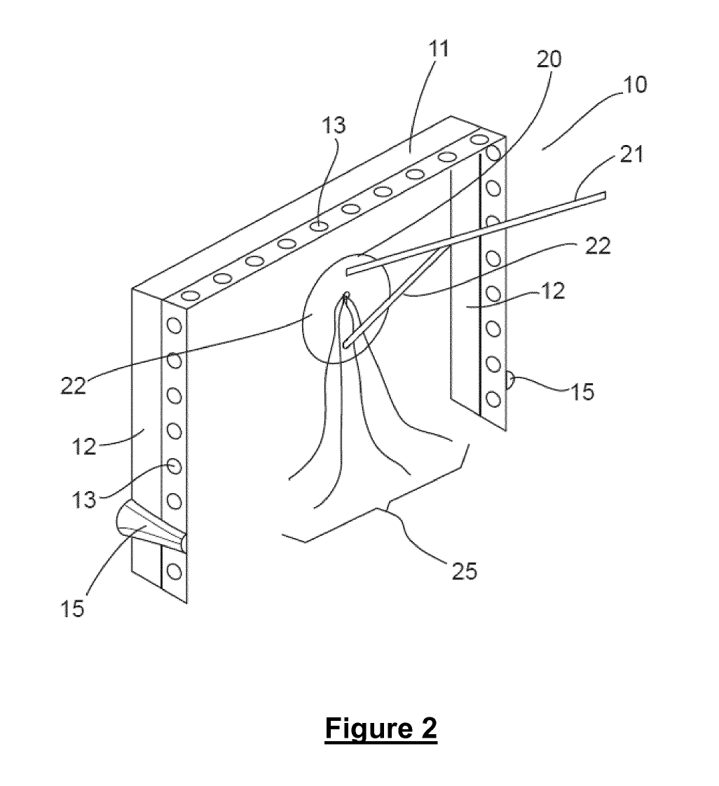

FIG. 2 is a perspective view of the aerodynamic drag reducing device of FIG. 1 with an inflatable enclosure removed;

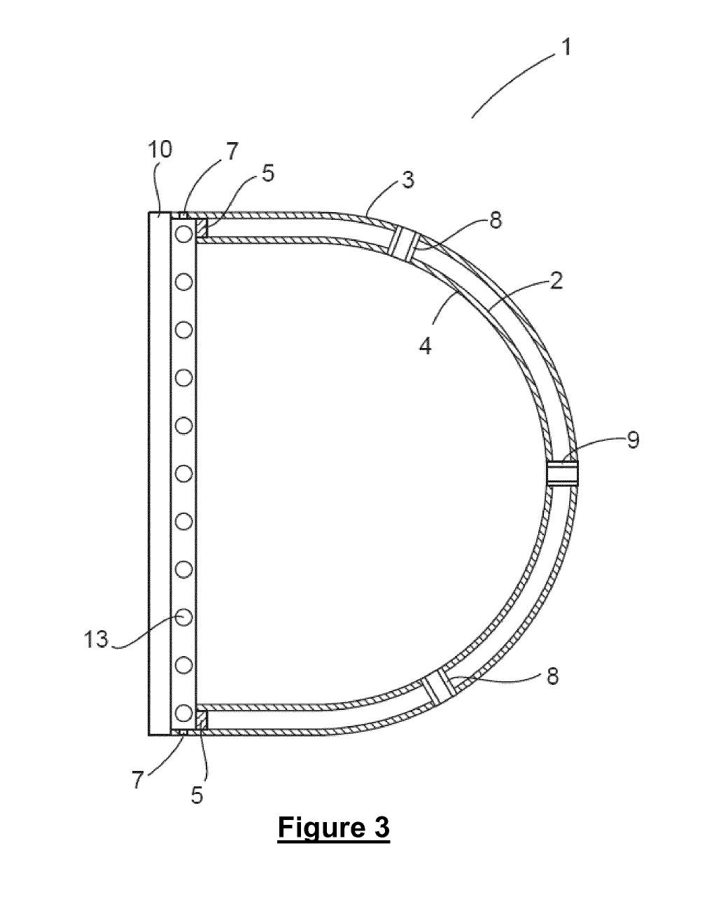

FIG. 3 is a plan transverse cross-sectional view along the lines III-III of the aerodynamic drag reducing device of FIG. 1;

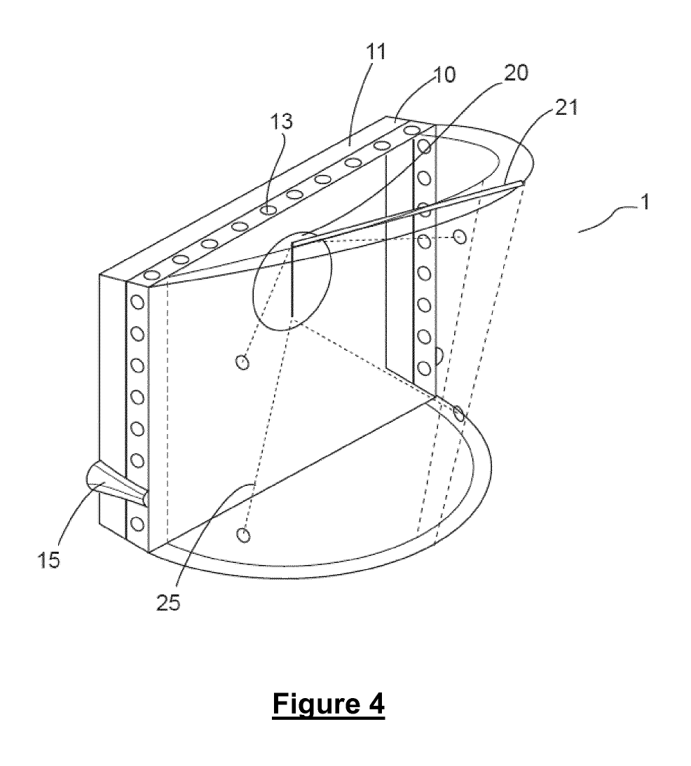

FIG. 4 is a schematic perspective see-through view of the aerodynamic drag reducing device of FIG. 1;

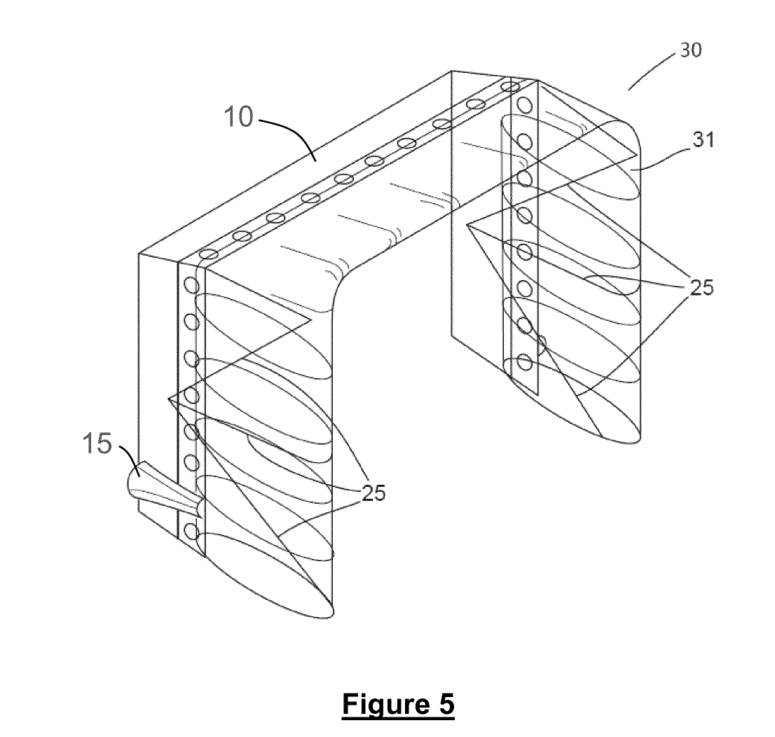

FIG. 5 is a perspective view of an aerodynamic drag reducing device according to an alternative embodiment of the present invention;

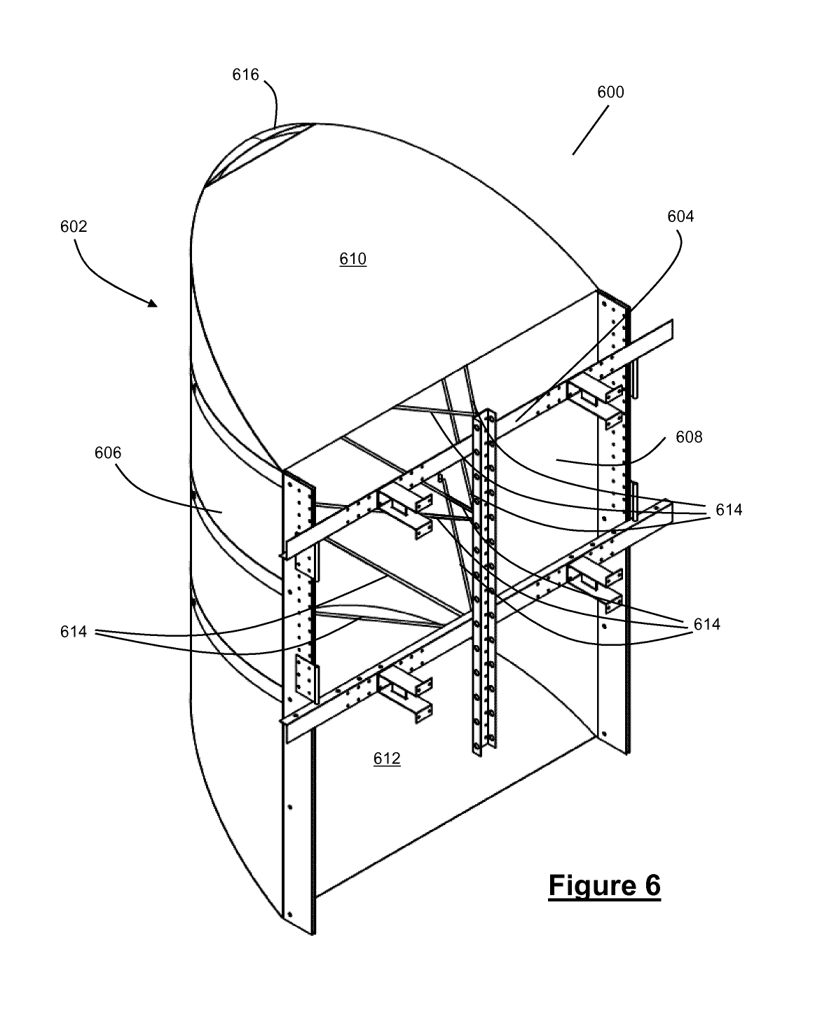

FIG. 6 is a perspective view of an aerodynamic drag reducing device according to a further embodiment of the present invention;

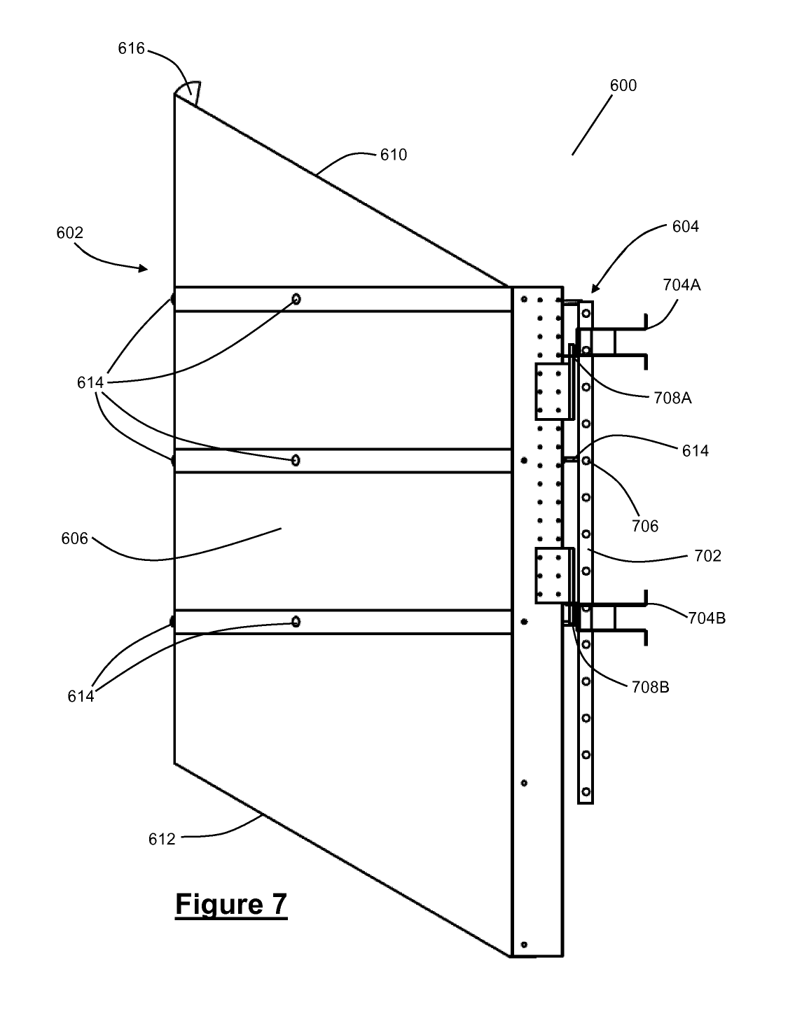

FIG. 7 is a side elevation view of the aerodynamic drag reducing device of FIG. 6;

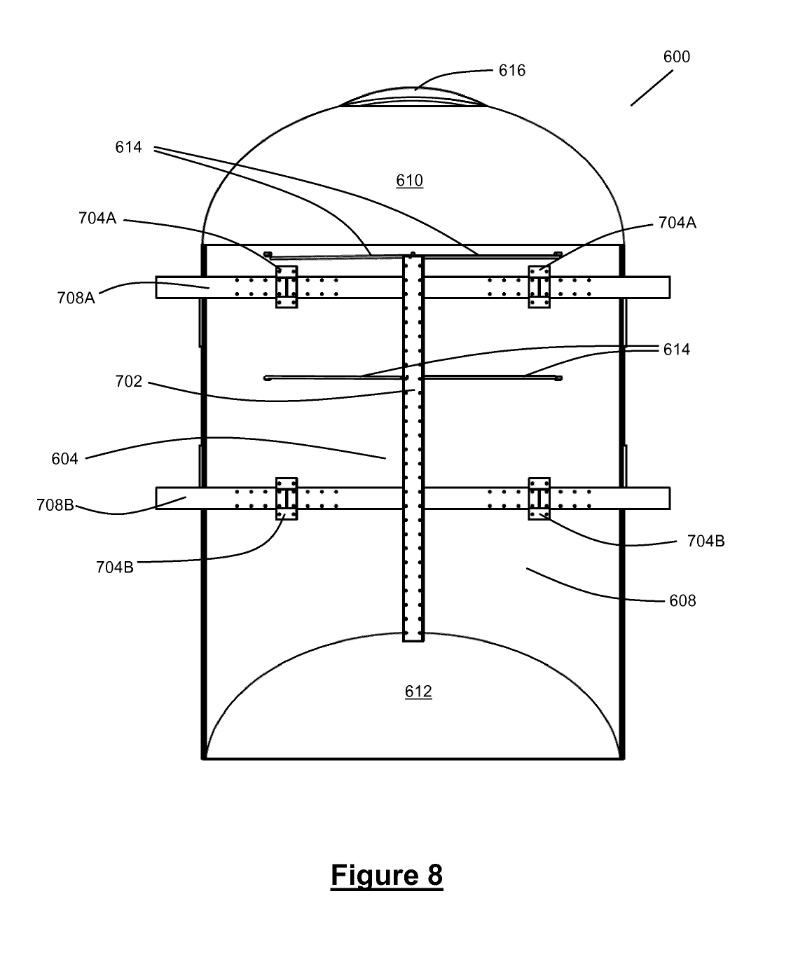

FIG. 8 is a rear elevation view of the aerodynamic drag reducing device of FIG. 6;

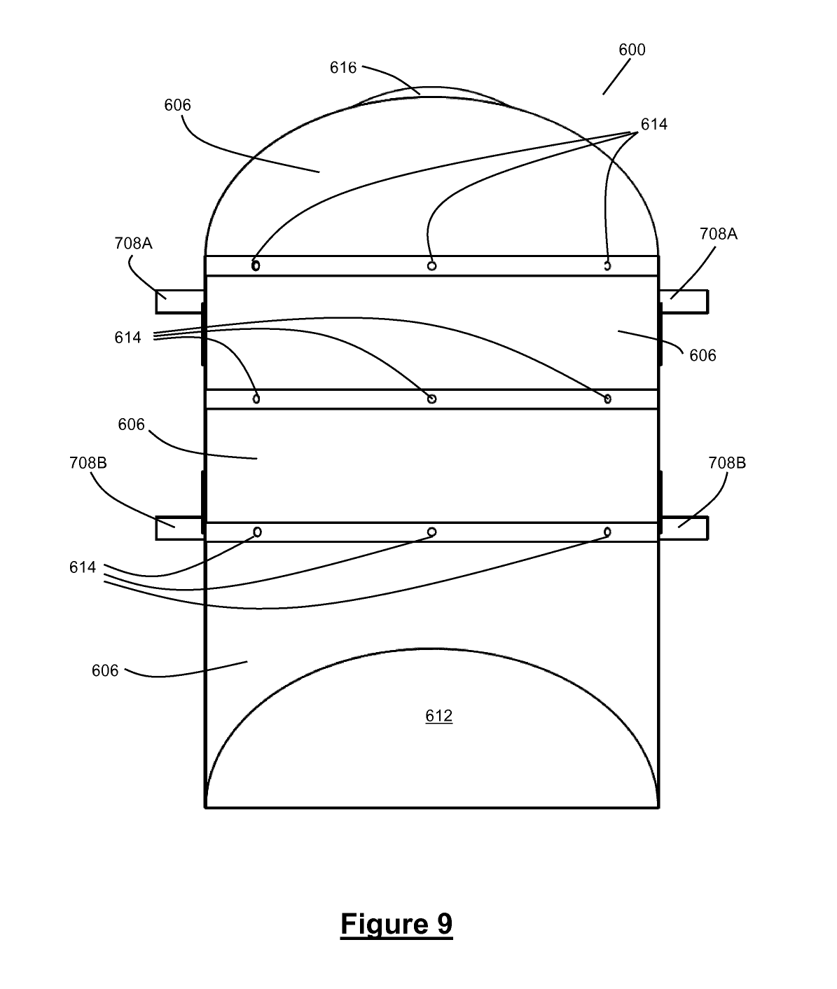

FIG. 9 is a front elevation view of the aerodynamic drag reducing device of FIG. 6;

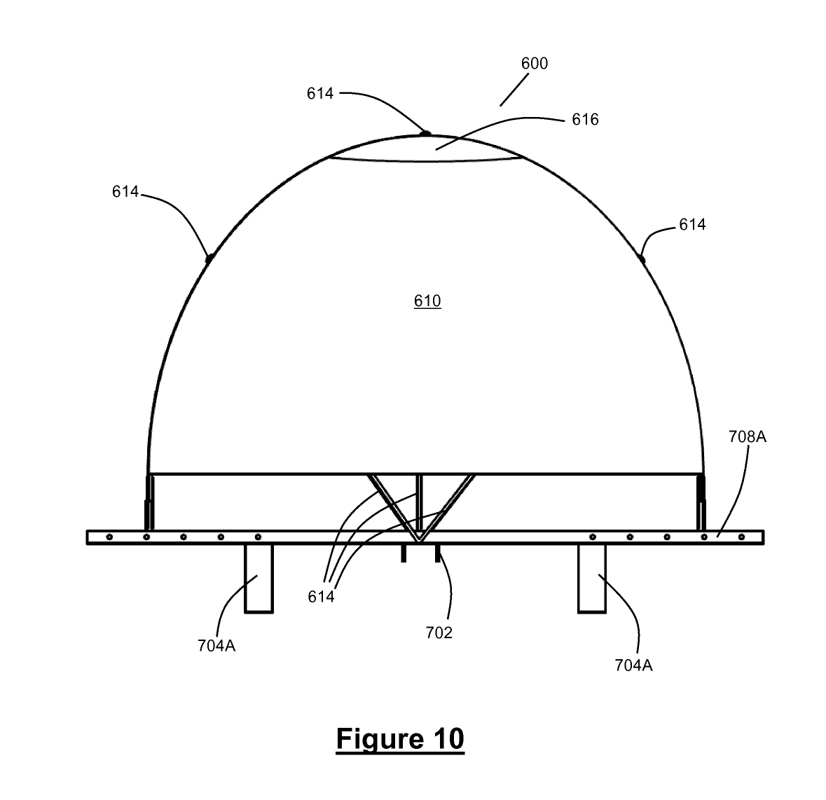

FIG. 10 is a top plan view of the aerodynamic drag reducing device of FIG. 6;

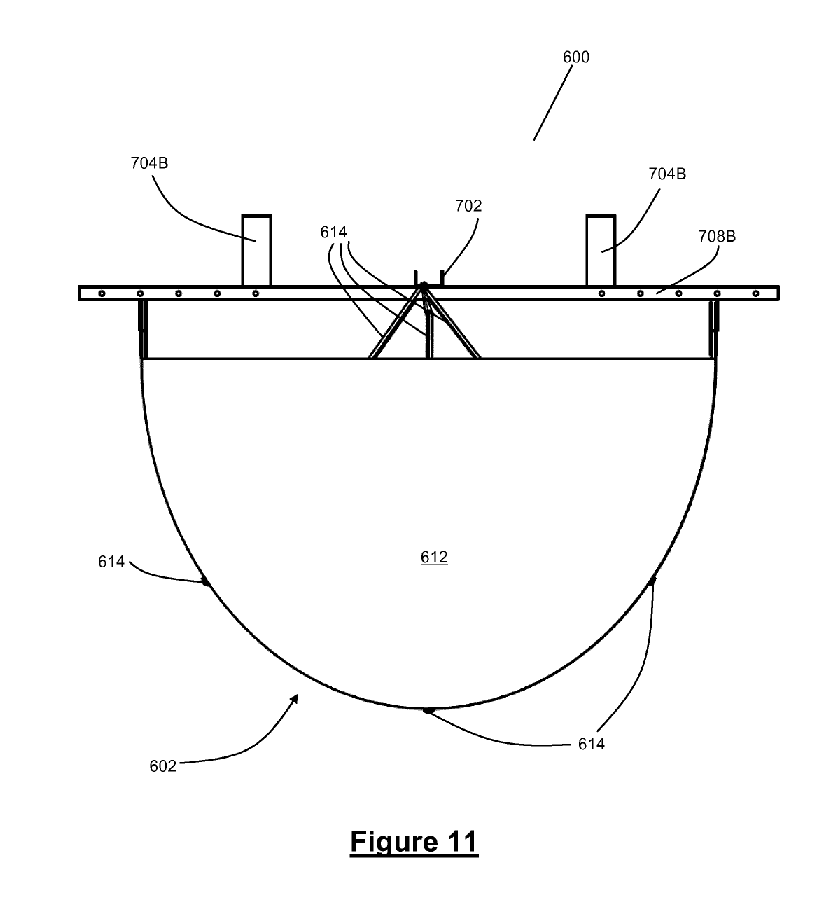

FIG. 11 is a bottom plan view of the aerodynamic drag reducing device of FIG. 6;

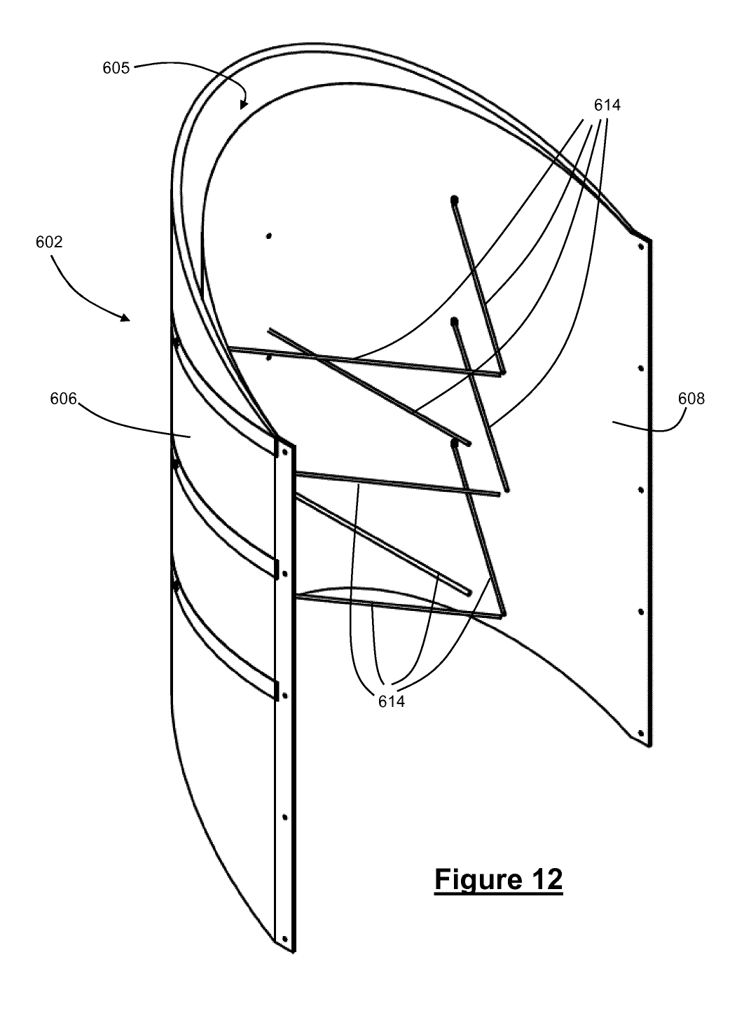

FIG. 12 is a perspective view of an inflatable enclosure of the aerodynamic drag reducing device of FIG. 6;

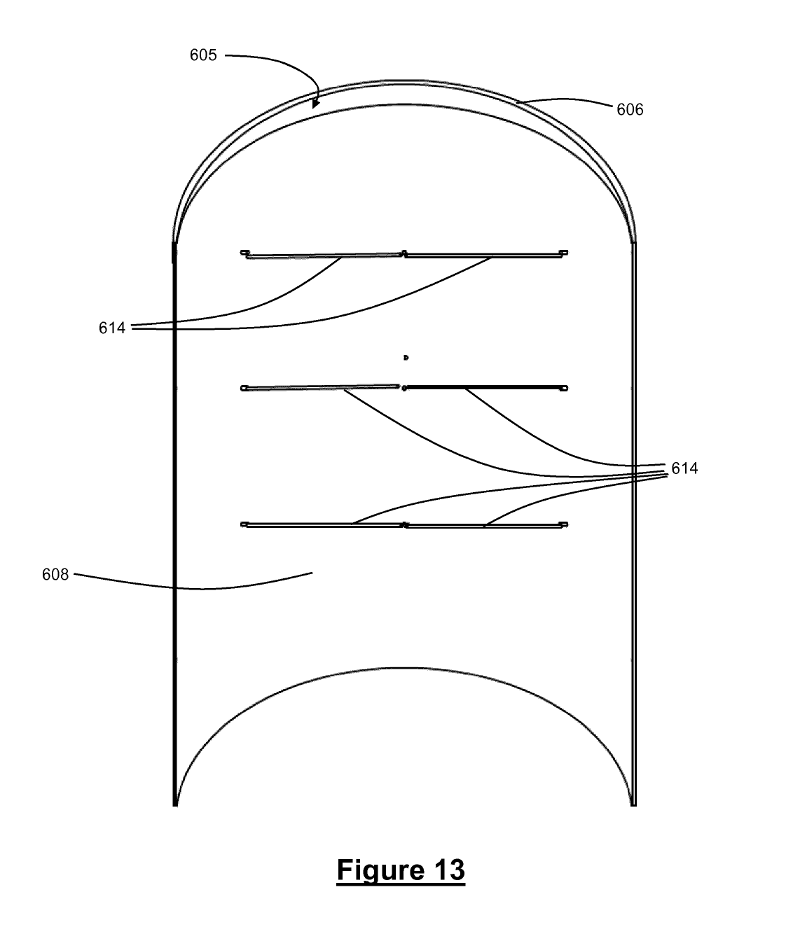

FIG. 13 is a rear elevation view of the inflatable enclosure of FIG. 12;

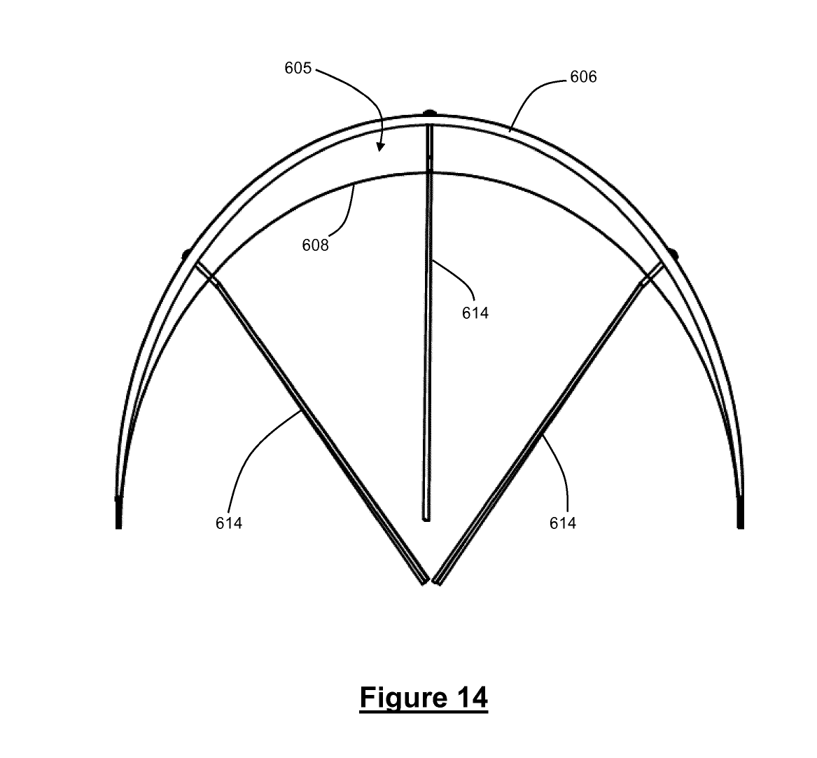

FIG. 14 is a top plan view of the inflatable enclosure of FIG. 12; and,

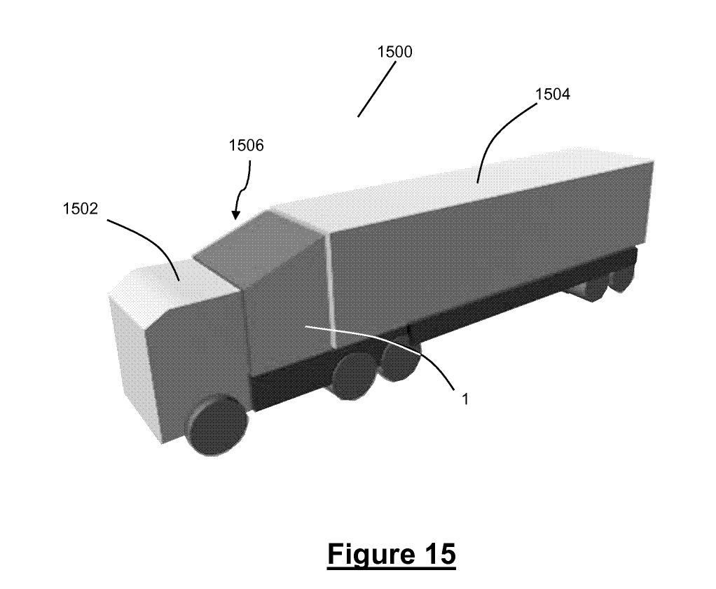

FIG. 15 is perspective view of an aerodynamic drag reducing device of the present invention connected to an articulated road vehicle.

Referring initially to FIG. 15, there is shown an aerodynamic drag reducing device indicated generally by reference numeral 1, installed on an articulated road vehicle 1500. The articulated road vehicle 1500 comprises a tractor unit 1502 and a trailer unit 1504. The tractor unit 1502 is oftentimes referred to as the cab unit and comprises the engine and driver portion of the articulated road vehicle 1500. The aerodynamic drag reducing device 1 is fitted and retained in a gap, indicated generally by reference numeral 1506, between the tractor unit 1502 and the trailer unit 1504.

Referring now to FIGS. 1 to 4 inclusive, there is shown an aerodynamic drag reducing device identified generally by reference numeral 1. The aerodynamic drag reducing device 1 comprises an inflatable enclosure indicated by reference numeral 2 having an outer wall 3 and an inner wall 4 connected by end walls 5.

The inner wall 3 and outer wall 4 are covered by a flexible top cover sheet 6. The end walls 5 abut against a support frame 10 shown in more detail in FIG. 2. It will also be noted that the outer wall 3 projects beyond the inner wall 4 and the outer wall 3 has fastening means 7 for attaching the inflatable enclosure 2 to the support frame 10.

A plurality of short connector tubes 8 and 9 are connected between the outer wall 3 and the inner wall 4 of the inflatable enclosure 2 for the reception of ties 25 and a support bar 21, as will be described in more detail hereinunder.

Referring specifically to FIG. 2 the support frame 10 comprises a top frame member 11 and two depending side frame members 12. The top frame member 11 and side frame members 12 have comprise a plurality of fastening means 13, which are complementary with and co-operate with the plurality of fastening means 7 of the outer wall 3 of the inflatable enclosure 2.

Mounted on each side frame member 12 is an air inlet 15 for connection to the inflatable enclosure 2. It will be readily understood that the air inlet 15 may not be mounted on the inflatable enclosure 2, and may be alternatively mounted on another portion of the aerodynamic drag reducing device 1, such as the support frame 10. In another embodiment, the aerodynamic drag reducing device 1 comprises a permanently inflated enclosure, which does not require to be inflated by air entering through any air intakes, as the aerodynamic drag reducing device 1 is inflated at manufacture or installation and then the outer wall 3 and the inner wall 4 are sealed on all sides to create a permanently inflated enclosure.

The dimensions of the support frame 10 are such as to allow mounting of the support frame 10 on the tractor unit of the articulated road vehicle. A mounting base plate 20 is provided in a substantially centralised position within the support frame 10. The mounting base plate 20 carries an outwardly and upwardly projecting support bar 21 to which is also strengthened by a further support strut 22. A plurality of flexible ties 25 are also carried by the mounting base plate 20.

In use, the support frame 10 and the mounting base plate 20, which is a part of the support frame 10, are secured to a rearwardly facing planar section of the tractor unit. Then the inflatable enclosure 2 is connected to the support frame 10 by way of the complementary fastening means 7 and 13. The ties 25 are used to connect the inflatable enclosure 2 through the connector tubes 8 to the mounting base plate 20. The support bar 21 engages and supports a central portion of the inflatable enclosure 2 through connector tube 9. The air inlets 15 are connected into the interior of the inflatable enclosure 2 to provide a flow of air into the inflatable enclosure 2 when the articulated road vehicle is being driven forward.

In operation, once the tractor unit has gained sufficient speed the inflatable enclosure 2 will inflate into an erected state and reduce the aerodynamic drag encountered by the articulated road vehicle. However, on slowing down or stopping the enclosure 2 will only slightly deflate as a semi-rigid foamed plastics material, such as woven propylene will be used for the construction of the inflatable enclosure 2, and this semi-rigid material will maintain the shape of the inflatable enclosure 2. The support bar 21 will also assist in maintaining the shape of the inflatable enclosure 2 during low speeds or when the articulated road vehicle is stationary.

The ties 25 will ensure that on slightly collapsing during deflation, the inflatable enclosure 2 will assume a relatively compact configuration. In other embodiments of the invention, the support bar 21 may be telescopic and indeed can be biased inwards toward the tractor unit, whereby on deflation of the inflatable enclosure 2, the inflatable enclosure 2 will be pulled inwards towards the tractor unit to further assist in ensuring that the inflatable enclosure 2 assumes a compact configuration. Similarly the flexible ties 25 may also be biased inwards either by being constructed of an elastic material or being mounted by means of springs on the mounting base plate 20.

The shape of the inflatable enclosure 2 in cross-section is important. The idea of having the free end of the inflatable enclosure 2 of arcuate configuration will allow flexibility in the connection of the inflatable enclosure 2 to the semi-trailer unit. This will further assist when executing a turning manoeuvre with the articulated road vehicle.

In an alternative use for the ties 25, the ties 25 may be used to cause the enclosure 2 to have a desired semi-circular shape, or more of a semi-oval shape. In order to achieve this, the ties 25 may be tightened and loosened to different tensions so as to impart the desired shaping to the inflatable enclosure 2.

It is envisaged that the support bar 21 may project above the trailer unit and may be releasably secured thereto for limited travel across the top of the semi-trailer unit.

Referring now to FIG. 5, wherein like parts previously described have been assigned the same reference numerals, there is illustrated an alternative construction of an inflatable enclosure which is indicated generally by reference numeral 30. In this embodiment it will be seen that the inflatable enclosure is essentially an inverted U-shape. The inflatable enclosure 30 includes a plurality of stiffening ribs 31, formed by rods assuming a substantially elliptical shape. These stiffening ribs 31 could also be incorporated in the inflatable enclosure 2 described above. The inflatable enclosure 30 is attached to a support frame 10 and comprises air inlets 15.

Referring now to FIGS. 6 to 14 inclusive, an alternative embodiment of an aerodynamic drag reducing device is shown and is indicated generally by reference numeral 600. The aerodynamic drag reducing device 600 comprises an inflatable enclosure indicated generally by reference numeral 602 attached to a support frame 604. The support frame 604 is mountable on a rearward facing planar section of a tractor unit on an articulated road vehicle (not shown). The inflatable enclosure 602 is made out of a semi-flexible material and is inflatable by air entering through at least one air inlet 616 connected to the inflatable enclosure 602. The air inlet 616 comprises an opening which is located on the substantially semi-circular top face 610 of the inflatable enclosure 602 adjacent an abutment point with the outer wall 606 of the inflatable enclosure 602. As mentioned hereinbefore, the aerodynamic drag reducing device 600 may comprise a permanently inflated enclosure in the place of the inflatable enclosure 602; and in such a circumstance, the aerodynamic drag reducing device 600 will not comprise any air inlet 616.

The inflatable enclosure 602 comprises an outer wall 606 and an inner wall 608 spaced apart and defining an air-receiving cavity 605 therebetween. The outer wall 606 and the inner wall 608 are curved so that the air-receiving cavity 605 defined therebetween is a substantially semi-annular when viewed in transverse cross-section. The inner wall 608 is preferably made of an airtight fabric, such as polyethylene. The outer wall 608 is preferably made of a semi-rigid foam such as a closed cell polyethylene foam as sold under the registered trademark STRATOCELL. The outer wall 608 may also comprise a weather-proof sheet made of a plastics material.

The inflatable enclosure 602 is formed into a substantially semi-cylindrical shape having an arcuate outer face formed by the outer wall 606 of the inflatable enclosure 602, and a substantially semi-circular top face 610 and a substantially semi-circular bottom face 612. The substantially semi-circular top face 610 slopes upwardly away from the supporting framework 604, and, the substantially semi-circular bottom face 612 also slopes upwardly away from the supporting framework 604.

In one embodiment, the aerodynamic drag reducing device 600 has radially extending support rods 614 which support the inflatable enclosure 602. The radially extending support rods 614 extend from a substantially vertical support post on the support frame 604 to a plurality of points on the inner wall 608 of the inflatable enclosure 602. In a further embodiment, the aerodynamic drag reducing device 600 has radially extending ties, which would replace the radially extending support rods 614 and which hold in and provide a shape to the inflatable enclosure 602. The radially extending ties extend from a substantially vertical support post 702 on the support frame 604 to a plurality of points on the inner wall 608 of the inflatable enclosure 602, in the same manner as the radially extending support rods 614. The radially extending ties are tensioned so as to form the inflatable enclosure 602 in a substantially semi-circular shape or a semi-oval shape, or other such desired shaped. The radially extending ties pass through holes 706 on the substantially vertical support post 702 and are secured to the substantially vertical support post 702.

It will be understood that the substantially semi-circular top face 610 and the substantially semi-circular bottom face 612 may take the form a substantially semi-oval sheets if the radially extending ties are tensioned so as to form the aerodynamic drag reducing device 600 into a different shape. It will be appreciated that the ability to form different shapes with the adjustable ties allows the aerodynamic drag reducing device 600 to be installed on differently dimensioned articulated vehicles.

An inner void is established between the inner wall 608 and the supporting frame 604, whereby the inner void is a substantially D-shaped area when viewed in transverse cross-section.

The support frame 604 comprises a substantially vertical support post 702 and a pair of substantially horizontal support posts 708A, 708B. The substantially horizontal support posts 704A, 704B are connected to the outer terminating ends of the inflatable enclosure 602. Connecting brackets 704A, 704B are connected to the substantially horizontal support posts 708A, 708B and the connecting brackets 704A, 704B allow the aerodynamic drag reducing device 600 to be secured to a tractor or trailer unit, as required. It will be understood, that the substantially vertical support post 702, the substantially horizontal support posts 708A, 708B and the connecting brackets 704A, 704B may be adjusted and altered in both the horizontal and vertical directions to ensure that the aerodynamic drag reducing device 600 can be secured to an articulated vehicle.

The dimensions for the aerodynamic drag reducing device 1, 600 will be approximately 1.7 m high at a tractor unit side of the aerodynamic drag reducing device 1, rising to approximately 2.3 m high at the trailer unit side of the aerodynamic drag reducing device 1, 600. The aerodynamic drag reducing device 1, 600 will be approximately 1.9 m in length. The aerodynamic drag reducing device 1, 600 is approximately 2.33 m wide, which is suitable for the majority of the articulated road vehicles which it is intended for use with. Although it will be readily appreciated that the dimensions of the aerodynamic drag reducing device 1, 600 can be altered to suit any size of vehicle which comprises a gap between a tractor unit and a trailer unit, or indeed, between a row of trailer units as would be found in a road train, or a conventional train having a plurality of carriages hitched in series. The aerodynamic drag reducing device 1, 600 is envisaged to weigh approximately 12 kilograms.

The inflatable enclosure 2, 602 comprises an air-receiving cavity 605 which will be in the range of 0 mm to 80 mm in width from the outer wall 3, 606 to the inner wall 4, 608.

In one embodiment, where the outer wall 606 is sealed on all sides to the inner wall 608 so as to form a permanently inflated enclosure 602; the air inlet 616 is left on the aerodynamic drag reducing device 600 as an air-catching pocket which does not inflate the aerodynamic drag reducing device 600, but rather causes an uplift of the aerodynamic drag reducing device 600.

In some embodiments, a vee-shaped notch cut into the bottom/underside of the aerodynamic drag reducing device 1, 600 is foreseen to allow for cables, wiring and hoses to connect the tractor unit and the trailer unit, or a pair of trailer units together.

Woven polypropylene plastic of a grade having a weight of 500 g per square meter is envisaged to be used for construction of the inflatable enclosure. Although plastics materials having a weight in the range of 250 g to 500 g per square meter may be used.

The crux of the invention is that it fills the gap between the tractor unit and the trailer unit and therefore reduces the aerodynamic drag on the articulated road vehicle. The aerodynamic drag reducing device 1, 600 can increase fuel efficiency by approximately 8%.

It will be understood that the aerodynamic drag reducing device 1, 600 may be equally applicable to trains, where a gap is found between carriages, and to so-called road trains where a plurality of trailer units are pulled behind a single tractor unit, with a gap between the tractor unit and the first trailer unit, and a gap between adjacent trailer units. In essence, any type of driven vehicle having a gapped hitch connection between sections would be suitable for use with the aerodynamic drag reducing device of the present invention.

It will be understood that alternatively, the support frame and/or inflatable enclosure may be mounted on a forward facing portion of a trailer unit, so as to retain the inflatable enclosure in the gap intermediate the tractor unit and the trailer unit, or in the gap between adjacent trailer units.

It will also be understood that a support frame is not strictly necessary if the inflatable enclosure can be mounted directly onto a tractor unit or trailer unit of an articulated road vehicle.

In this specification the terms “comprise” and “include” and any necessary grammatical variations thereof are used interchangeably and are to be afforded the widest possible interpretation.

The invention is not limited to the embodiments described above but may be varied in both construction and detail within the scope of the appended claims.

1. An aerodynamic drag reducing device for an articulated road vehicle;
the articulated road vehicle comprising a tractor unit and a trailer unit, with the trailer tractor unit pivotably connectable to the tractor unit such that a gap is formed intermediate the tractor unit and the trailer unit when the trailer unit is connected to the tractor unit;
the aerodynamic drag reducing device comprising an inflatable enclosure attached to a support framework;
the support framework being mountable on at least one of: a rearward facing portion of the tractor unit or a forward facing portion of the trailer unit, so as to retain the inflatable enclosure in the gap intermediate the tractor unit and the trailer unit;
the inflatable enclosure being made of a flexible material;
wherein,
the inflatable enclosure comprises an outer wall and an inner wall spaced apart and defining an air-receiving cavity therebetween; and,
the outer wall and the inner wall being curved respectively so that the air-receiving cavity defined therebetween comprises a substantially semi-annular transverse cross-section.

2. An aerodynamic drag reducing device as claimed in claim 1, wherein, the inflatable enclosure is inflated by air entering through at least one air inlet connected to the inflatable enclosure

3. An aerodynamic drag reducing device as claimed in claim 1, wherein, when the air-receiving cavity is inflated, an inner void is established between the inner wall and the supporting framework, whereby the inner void comprises a substantially D-shaped transverse cross-section.

4. An aerodynamic drag reducing device as claimed in claim 1, wherein, the aerodynamic drag reducing device further comprises radial support rods which support the inflatable enclosure, from a substantially vertical support post on the support framework, at a plurality of points on the inner wall of the inflatable enclosure.

5. An aerodynamic drag reducing device as claimed in claim 1, wherein, when the air-receiving cavity is inflated, the inflatable enclosure is formed into a substantially semi-cylindrical shape having an arcuate outer face formed by the outer wall of the inflatable enclosure, and a substantially semi-circular top face and a substantially semi-circular bottom face.

6. An aerodynamic drag reducing device as claimed in claim 5, wherein, the substantially semi-circular top face slopes upwardly away from the supporting framework.

7. An aerodynamic drag reducing device as claimed in claim 5, wherein, the substantially semi-circular bottom face slopes upwardly away from the supporting framework.

8. An aerodynamic drag reducing device as claimed in claim 2, wherein, the inflatable enclosure is attached to a first side of the support framework, which is adjacent a first side of the tractor unit; and the outer wall of the inflatable enclosure arches outwardly away from the tractor unit to a substantially centralised outermost point before curving back towards the tractor unit so as that the inflatable enclosure is attached to a second side of the support framework, which is opposite the first side of the support framework and is also adjacent a second side of the tractor unit.

9. An aerodynamic drag reducing device as claimed in claim 8, wherein, the at least one air inlet comprises an opening which is located on the substantially semi-circular top face of the inflatable enclosure adjacent an abutment point with the outer wall of the inflatable enclosure.

10. An aerodynamic drag reducing device as claimed in claim 1, wherein, the at least one air inlet comprises a pair of conically shaped funnels which direct air into the air-receiving cavity of the inflatable enclosure.

11. An aerodynamic drag reducing device as claimed in claim 10, wherein, the pair of conically shaped funnels are located on either side of the inflatable enclosure.

12. An aerodynamic drag reducing device as claimed in claim 1, wherein, the inner wall is comprised of a semi-rigid plastics foam material.

13. (canceled)

14. An aerodynamic drag reducing device as claimed in claim 1, wherein, the inflatable enclosure is attached to the support framework using a plurality of fastening means.

15-17. (canceled)

18. An aerodynamic drag reducing device as claimed in claim 1, wherein, the inflatable enclosure is attached to the support framework using a zip.

19. An aerodynamic drag reducing device as claimed in claim 1, wherein, the inflatable enclosure comprises at least one air outlet.

20. An aerodynamic drag reducing device as claimed in claim 19, wherein, the at least one air outlet is adjustable in dimension to permit a greater or lesser rate of air flow through the at least one air outlet.

21. An aerodynamic drag reducing device as claimed in claim 2, wherein, the at least one air inlet is adjustable in dimension to permit a greater or lesser rate of air flow through the at least one air inlet.

22. An aerodynamic drag reducing device as claimed in claim 1, wherein, the aerodynamic drag reducing device further comprises radially extending ties which bias the inflatable enclosure towards a retracted state when the inflatable enclosure is not inflated, wherein the radially extending ties extend, from a substantially centralised position on the framework, radially outwardly towards a plurality of points on the inner wall of the inflatable enclosure.

23. An aerodynamic drag reducing device as claimed in claim 1, wherein, the inflatable enclosure comprises a hose and wiring channel provided on a bottom face of the inflatable enclosure.

24. An aerodynamic drag reducing device as claimed in claim 1, wherein, the inflatable enclosure is comprised of a woven polypropylene plastics material.
